(19) United States
(12) Patent Application Publication
(10) Pub. No.: US 2018/0272322 A1
(43) Pub. Date: Sep. 27, 2018

(54) CATALYST FOR DRY REFORMING METHANE TO SYNTHESIS GAS

(71) Applicant: EXTIEL-GPG, LLC, Houston, TX (US)

(72) Inventors: GREG CARR, Houston, TX (US); Michael O'Brien, Houston, TX (US); David Devilliers, Seabrook, TX (US)

(21) Appl. No.: 15/927,633

(22) Filed: Mar. 21, 2018

Related U.S. Application Data
(60) Provisional application No. 62/475,613, filed on Mar. 23, 2017.

(51) Int. Cl. B01J 23/755; B01J 23/745; B01J 23/75; B01J 37/08; C01B 3/40

(52) U.S. Cl. CPC B01J 23/755; B01J 23/745; B01J 23/75; B01J 37/08; C01B 2203/1047; C01B 2203/0238; C01B 2203/1058; C01B 2203/1052; C01B 3/40

(57) ABSTRACT

A dry reforming methane to synthesis gas catalyst is provided. The catalyst has a primary metal of magnesia (MgO). A secondary metal is mixed with the primary metal. The primary metal and the secondary metal have crystalline structures that are close to one another so as to be in solid solution with the support and form a mono-crystalline structure.

### FIELD OF THE INVENTION

The present invention relates to catalysts for dry methane reforming of methane or a high methane containing feed gas to synthesis gas.

### BACKGROUND OF THE INVENTION

In dry methane reforming, methane (CH₄) and carbon dioxide (CO₂) are passed over a catalyst under appropriate temperature and pressure conditions and converted to synthesis gas or syngas (hydrogen (H₂) and carbon monoxide (CO)). The process is endothermic and heat must be applied. Dry methane reforming, or DMR, is used in the gas-to-liquids industry.

Syngas is used in a Fischer-Tropsch process to produce hydrocarbons such as gasoline, diesel, oils, paraffins, etc. In a Fischer-Tropsch process, syngas is contacted with a Fischer-Tropsch catalyst under appropriate temperature and pressure conditions to produce the hydrocarbons. By selecting the catalyst and the operating conditions, the desired hydrocarbons can be produced.

The catalyst in DMR is typically a solid metal heterogeneous catalyst. A catalyst metal is located on a catalyst support. The catalyst support is typically of metal or metal oxide. Because DMR operates under dry conditions, free of steam, carbon accumulates on the catalyst, a process known as coking. Coking reduces the effectiveness of the catalyst and requires maintenance. Coking also reduces the commercial viability of dry methane reforming. Introducing steam reduces coking of the catalyst, but causes other problems, such as reduced throughput.

It is desired to provide a catalyst that exhibits reduced coking.

There are alternative methods of producing syngas. For example, steam methane reforming passes methane and steam over a catalyst. The reforming process to produce syngas is highly endothermic. Therefore, a heat source is provided. As another example, catalytic partial oxidation (CPOx) combusts methane in air over a catalyst. The process is exothermic due to the combustion.

Dry methane reforming offers advantages over these other processes. In addition to the feed gases being different, the ratio of syngas components, hydrogen to carbon monoxide, can be adjusted with dry methane reforming.

### SUMMARY OF THE INVENTION

A dry reforming methane to synthesis gas catalyst comprises a primary metal based material of magnesia (MgO). The primary metal based material has a first crystalline structure. A secondary metal based material has a second crystalline structure. The secondary metal based material mixed with the primary metal based material. The primary and secondary metal based materials have been heated so the first and second crystalline structures form a mono-crystalline structure.

In accordance with one aspect, the first crystalline structure has a first lattice parameter and the second crystalline structure has a second lattice parameter.

In accordance with another aspect, the second lattice parameter is within 2% of the first lattice parameter.

In accordance with another aspect, the secondary metal based material is taken from the group consisting of nickel oxide (NiO), cobalt oxide (CoO) and iron oxide (FeO).

In accordance with another aspect, the dry reforming methane to synthesis gas catalyst further comprises a tertiary metal based material that is different from the secondary metal based material and is taken from the consisting of nickel oxide (NiO), cobalt oxide (CoO) and iron oxide (FeO).

In accordance with another aspect, the primary metal based material and the secondary metal based material have a eutectic temperature, the primary metal based material and secondary metal based material have been calcined at a temperature above the eutectic temperature to form sintered metal oxides.

In accordance with another aspect, the catalyst further comprises a solid solution phase promoter.

In accordance with another aspect, the catalyst further comprises an alkalinity promoter.

### BRIEF DESCRIPTION OF THE DRAWINGS

FIG. 1 is a diagram showing a dry methane reforming plant.

FIG. 2 is a diagram showing a cross-section of pores of a catalyst support before the catalyst metal is impregnated thereon.

FIG. 3 is a diagram showing the pores of the catalyst support of FIG. 2, partially impregnated with the catalyst metal.

FIG. 4 is a diagram showing the catalyst support of FIG. 2, impregnated with the catalyst metal.

### DESCRIPTION OF THE PREFERRED EMBODIMENT

The dry methane reforming catalyst uses a solid solution that reduces coking. The primary catalyst metal is in solid solution with the secondary catalyst metal, creating a non-segregated crystallographic structure.

With prior art catalysts, the individual metal oxide components are segregated crystallographic entities that allow migration of these species to and from the catalyst surface during reforming operations. This migration encourages or promotes coking at the catalyst surface. A solid solution catalyst reduces or eliminates the migration.

In addition, it is believed that the catalyst will display enhanced resistance to higher than normal levels of sulfur in feed gas streams. Such normal levels are the typical tolerance levels for conventional metal-supported catalysts. Thus, the catalyst can tolerate higher sulfur levels than conventional catalysts.

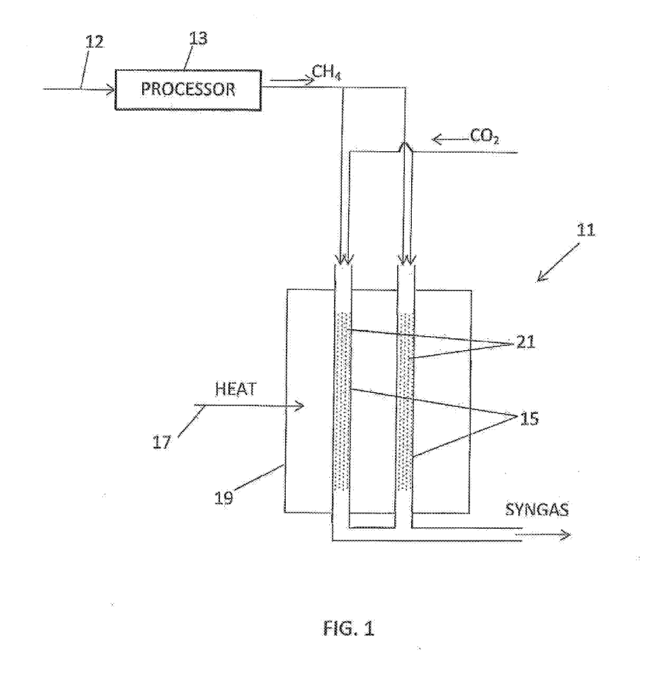

Before the catalyst is discussed in more detail, a brief description of the dry methane reforming equipment is provided. Referring to FIG. 1, a dry methane reformer 11 is shown schematically. The reformer 11 uses methane and carbon dioxide. In addition to providing feedstock for the production of other products, the reformer captures and sequesters carbon and carbon dioxide, a greenhouse gas. The methane is obtained from natural gas, which is delivered by way of a pipeline 12. The pipeline can deliver the natural gas from any number of sources, such as wells, underground storage facilities, etc. Natural gas is primarily methane and/or a methane rich gas, which may contain contaminants which are not methane. Typically, the natural gas is processed in one or more processors 13 to remove contaminants. For example, the processor can involve a hydrogenation vessel which removes sulfur contaminants and forms H₂S gas. The H₂S is removed from the methane by a zinc oxide bed. Alternative sources of the methane include bio-derived gas (such as from landfills or from anaerobic digesters), natural gas liquids (NGLs) and substitute natural gas (SNG).

The carbon dioxide can come from a variety of sources. For example, flue gasses from fossil fuel plants contain CO₂. Also, CO₂ is produced by ammonia synthesis. Landfills, biomass and municipal solid waste (MSW) are sources of CO₂, as is coal gasification derived gas. If needed, the CO₂ can undergo processing to remove impurities.

The methane and CO₂ are provided to reactor tubes 15, which reactor tubes are located inside of the dry methane reformer 11. More specifically, the methane and CO₂ are provided to manifolds that then distribute the gasses to the individual reactor tubes 15. The catalyst 21 is located inside the reactor tubes 15. Because the reaction is endothermic, heat 17 must be applied. A typical heat source is to route some of the methane to burners located inside of the reformer 11. The burners combust the methane and provide heat 17 to the reactor tubes 15. The reformer 11 has insulated walls 19 that enclose the space around the burners 17 and form the exterior of the reformer, holding the reactor tubes 15.

The reformer provides the operating conditions needed for the reaction. Such operating conditions include temperature and pressure of the gasses and catalyst inside the reactor tubes 15.

The catalyst converts the methane and CO₂ to syngas, which syngas enters a manifold at the bottom of the reformer 11. The syngas may contain other components, which can be removed from the stream by processing equipment. Also, the syngas ratio of H₂:CO may be adjusted as desired. The syngas is then provided to a Fischer-Tropsch reactor, which converts the syngas into a product, such as waxes, or other hydrocarbons. Waste heat contained in the syngas leaving the reformer 11 can be recaptured for other uses.

The catalyst will now be discussed in more detail. In the description herein, terms such as “primary metal based material” and “primary metal” may be used interchangeably, as may terms “secondary metal based material” and “secondary metal”.

The components of the catalyst include a primary metal based material and a secondary metal based material. The primary metal based materials in solid solution with the secondary metal based material. In choosing the components for a solid solution catalyst, several factors are considered. The crystalline structures of the components should closely match or be comparable. In addition, electronegativity (valency), component alkalinity and atomic radii are additional factors, although not as major as crystalline comparability.

In considering components with comparable crystalline structures, one measure is the crystal lattice parameter. The lattice parameter is an X-ray diffraction (XRD) measured property denoting the spacing distance between adjacent crystal planes. Among many metal oxides, magnesia (MgO) has a substantially similar lattice parameter as nickel(II) oxide (NiO). Nickel is a commonly use base metal for dry reforming. As a result, these two metal oxides can form a solid solution matrix, with a combined single crystalline phase in which the ratio of these two components can vary without disturbing the homogeneity of the solid solution. The following table shows candidates for an MgO based catalyst (with MgO being the primary metal based material, or primary metal):

| | Lattice Parameter | % Difference |
|---|---|---|
| Metal Oxide | (angstroms) | with MgO |
| MgO | 4.2112 | — |
| NiO | 4.1684 | 1.02 |
| CoO | 4.2667 | 1.32 |
| FeO (on Fe₃O₄) | 4.2774 | 1.57 |
| RuO | 2.7000 | 35.89 |

As can be seen from the table, nickel(II) oxide (NiO) is closest to MgO and is preferred. Cobalt(II) oxide (CoO) and iron(II) oxide (FeO) are also close and may be used. NiO, CoO or FeO are within 2% (in terms of lattice parameter) of MgO and either can be used as the secondary metal (or secondary metal based material) for the catalyst that is primarily based on MgO. In addition, as explained below, the catalyst can have an optional tertiary metal (or tertiary based metal material). Either NiO, CoO or FeO can be used as the tertiary metal for the catalyst. Any combination of NiO, CoO or FeO can be used in the catalyst as secondary and tertiary metals.

The lattice parameter of ruthenium oxide (RuO) is much smaller than MgO; use thereof with MgO will result in a non-optimal solid solution and, hence, be more prone to coking of the corresponding catalyst.

Regarding the other factors, such as alkalinity, in general, the more alkaline the catalyst is, the less it will coke. Optionally, potassium (K) can be used to as an alkalinity promoter. Electronegativity relates to basicity, which affects coking. For example, MgO is basic and will coke less, while in contrast, alumina is relatively acidic and will coke more.

Cobalt can optionally be used as a solid solution phase promoter. To this end, cobalt, in conjunction with nickel, can be used to form a tertiary phase solid solution catalyst in a variety of solid solution catalysts where MgO is the primary component.

The secondary metal is mixed with the primary metal. For example, the primary and secondary metals can be in powdered form. In the description that follows, nickel is used as the secondary metal. The secondary metal is obtained from the precursor nickel (II) nitrate [Ni(NO₃)₂]. The amount of nickel nitrate is such that the finished catalyst has 10-15% by weight of nickel (as NiO). Alternatively, the amount of nickel by weight can be 5-25% of the catalyst. The primary and secondary metals are mixed together.

Once mixed, the primary and secondary metals are calcined. Calcination decomposes the precursors, creates solid state reactions between the secondary metal and the primary metal, creates reactions between the secondary metal and the primary metal sintering the metal oxides. A high temperature ensures decomposition of the precursor salt(s). Calcination occurs at 900-1200 degrees C. in air for 2-8 hours to render the finished solid solution NiO—MgO catalyst. Once calcined to a dark green or olive color, the material is ready to use as a solid solution catalyst.

The catalyst material can be poured into ingots during calcination. Once the material cooled, the ingots are broken or milled into smaller pieces, such as spheres or balls.

Calcination can occur before the catalyst is loaded into the reformer. Alternatively, calcination can occur during initial heating of the reformer. In such a case, the catalyst is formed into the desired shape and size, pre-calcined and then loaded into the reformer. Calcining in situ in the reformer can lead to reduced manufacturing costs.

Calcination occurs above the eutectic temperature of the solid solution precursors. Once calcined, the secondary metal forms a mono-crystalline structure with the primary metal. Such a structure presents little or no crystal breaks or edges on which coke can form.

As an option, a tertiary metal can be used. The tertiary metal can be mixed in with the primary and secondary metals. For example, cobalt nitrate [Co(NO₃)₂] can be used as a tertiary metal in conjunction with the nickel nitrate [Ni(NO₃)₂]. The amount of cobalt nitrate is 100-1000 ppm and is added to the nickel nitrate solution to be applied at the same time as the nickel nitrate. The cobalt forms a tertiary solid solution catalyst (NiO—CoO—MgO). As an alternative, the cobalt can be applied to the binary compound after the Ni impregnated binary compound is pre-calcined and before final calcination.

The tertiary metal can be applied to the primary and secondary metals by incipient wetness impregnation, spraying or some other technique. The primary and secondary metals have pores that pick up the tertiary metal solution, such as by capillary action. The water pickup volume may range from 10-80%. Preferably, the impregnation occurs in one pass or step. However, if insufficient tertiary metal is applied or deposited, additional passes can be used.

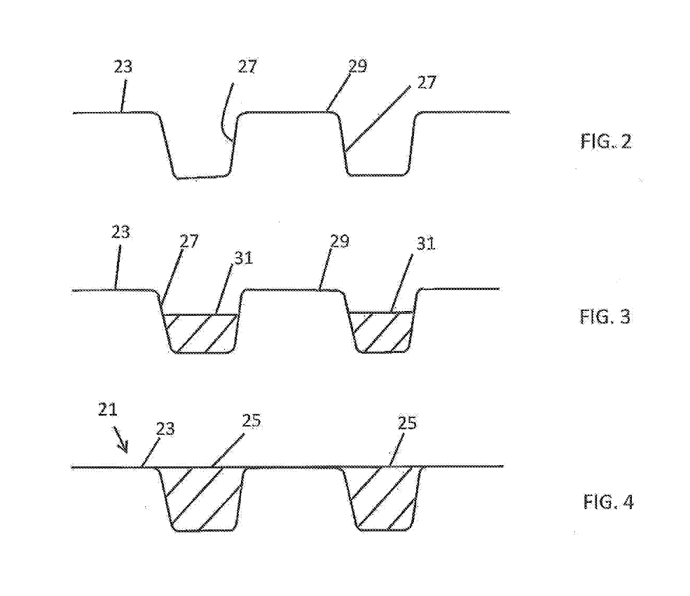

FIG. 2 illustrates the primary and secondary metals 23, which forms a binary compound with pores 27 in the surface 29 thereof. During the incipient wetness impregnation steps, the tertiary metal solution 31 is applied to the binary compound, which solution enters the pores 27. FIG. 3 illustrates an example of where the pores are partially filled with the solution. The water can be driven off by drying before calcination occurs. Drying is for 1-2 hours at 100 degrees C. in air. If additional tertiary metal is needed, then subsequent passes can be used to impregnate the pores with the tertiary metal solution. Although FIG. 4 shows the pores 27 filled with the tertiary metal, the pores 27 need not be completely filled, and may be partially filled such as shown in FIG. 3.

Once the binary compound has been impregnated with the desired amount of tertiary metal precursor, the resultant tertiary compound undergoes calcinations.

MgO is a good primary metal choice because it can be formed into a variety of sizes and shapes after combining with the secondary metal to form a binary compound. The surface area of MgO stabilizes the formed binary compound, at high temperatures, making it a good candidate for forming solid solutions with a variety of base metal oxides, across a wide range of calcining temperatures. Alumina is less desirable as a primary component because it transforms to low surface area α-alumina (corundum) around 1000 degrees C. calcining temperature, coupled to an unwanted spinel formation with a secondary metal, which is present in the oxide phase.

The binary compound that is created from MgO and the secondary metal can be in granular, pelleted, spray dried, tableted or extruded form. Examples of extrudates include round cylinders and trilobes. The magnesia has a nominal particle range of 50 microns to 2 inches. However, the particles are sized for the reactor tubes. For example, the ratio of reactor tube inside diameter to the particle diameter ranges best from 10:1 to 25:1. Also, for effective plug flow hydrodynamics in the reactor tubes, the ratio of catalyst bed height (or length) to the particle diameter ranges from 20:1 to 1000:1 and preferably exceeds 500:1. The higher end of these ratios is limited by the pressure drop over the reformer tube.

The binary compound selected in a form and size in accordance with the desired particle size(s) to meet the aforementioned reactor requirements. The MgO primary component that is used for forming the binary compound may be reinforced with a carbon material, such as multi wall carbon nanotubes.

The binary compound consisting of the primary and secondary metals can also be applied to a third material, which is a support material.

The binary compound is then applied to the support using incipient wetness impregnation or precipitation techniques. In the description that follows, nickel is used as the secondary metal and MgO as the primary metal based material. However, as previously noted, other secondary metal based materials can be used, such as cobalt (II) oxide (CoO) or iron (II) oxide (FeO). The secondary metal is obtained from the precursor nickel (II) nitrate [Ni(NO₃)₂] and is put into solution with deionized water. The same approach can be used, selecting cobalt (ii) nitrate or iron (ii) nitrate as precursor for the corresponding metal based components. In the case of nickel nitrate it is such that the finished catalyst has 10-15% by weight of nickel (as NiO). Alternatively, the amount of nickel by weight can be 5-25% of the catalyst.

As an option, the primary and secondary metals can undergo a pre-calcination step to evaluate the formation of the solid solution phase before it is physically attained by way of the subsequent higher temperature calcination step. The substrate is heated at 300-650 degrees C. for 2-8 hours in air.

As an optional step, an alkalinity promoter can be provided, which further suppresses coking. For example, potassium nitrate (KNO₃) can be used as a precursor to deposit potassium oxide (K₂O) on the catalyst surface. The solid solution catalyst is post-impregnated with an aqueous solution of the potassium precursor. After calcining the binary compound, a solution of KNO₃ in deionized water is applied to the binary compound to obtain a net loading of potassium of 100-1000 ppm on the surface of the catalyst. The catalyst is then subjected to a final calcination at 300-650 degrees C. for 2-8 hours in air to form K₂O, potassium oxide. As an alternative, the aqueous K precursor solution (KNO₃) can be co-mixed with the aqueous nickel nitrate solution, so that Ni and K are applied at the same time. Alternatively, the K precursor solution may be co-mixed with either iron or cobalt nitrate solutions in the same fashion, because all solutions are in aqueous solution.

As an alternative, the catalyst can be prepared using a co-precipitation method. A first aqueous solution of Ni, Mg, K (and/or Co) nitrates and deionized water is prepared. A second aqueous solution of potassium carbonate (K₂CO₃) or potassium hydroxide (KOH) in deionized water is prepared. Both the first and second solutions are boiled. Then the first solution is added to the second solution, rapidly stirring to combine the solutions. Then, immediately the MgO precursor solution in deionized water, such as magnesium (ii) nitrate, is added to the combined solution to form a final solution for incipient wetness or pH directed precipitation of the metals onto the carbon based substrate. The impregnated substrate is then washed with deionized water, and then subjected to pre-calcination and then calcination, as discussed above. Any commercially available MgO based precursor, such as magnesium (ii) acetate, can be used in conjunction with the corresponding nickel and potassium based acetate salts, dissolved in deionized water.

The resulting catalyst has Ni and Mg as solid solution entities and exhibits reduced coking during the production of syngas. Coking behavior of such catalysts is significantly countered by only having a minute portion of active metal liberated from the bulk solid solution towards the catalytic surface, i.e. to be available during activation (reduction) of the catalyst only, not for synthesis. The Ni and Mg are in 99% mono-crystalline solid solution phase. Less than 1% is segregated, distinguishable, Ni. The Ni/Mg solid solution crystallite size is 5-50 angstroms. The catalyst BET surface area is 1-50 m²/g. The Ni to Mg mass ratio is 0.05 to 0.33. Also, the total concentration of K is 0-1000 ppm and the total concentration of Co is 0-1000 ppm.

Furthermore, it is believed that the catalyst resists higher levels of sulfur than other, conventional, catalysts. The lack of metals segregation in the solid solution catalyst plays a role in countering the sulfur-poisoning mechanism, because sulfur molecules only attack segregated nickel phases to form standalone nickel-sulfur bonds.

Any commercially available MgO substrate, nickel nitrate and potassium nitrate salts can be used. However, these should have at least 95% purity. Alternative precursors for Ni include Ni acetate and Ni carbonate. Alternative sources of Mg include Mg nitrate, Mg acetate and Mg carbonate. Alternative precursors for K are K acetate and K carbonate. Alternative precursors for Co are Co acetate and Co amine carbonate.

To use the catalyst, it undergoes a reduction/activation process. Feed gas, a mixture of H2 and N2 gasses, is passed over the catalyst. The feedgas composition can range from 5% H2 and 95% N2 to 100% H2 and 0% N2. The process occurs at 500-1000 degrees C. and at a pressure range of atmospheric pressure to 5 bars. The temperature ramping rate is 10-100 C per hour. The Gas Hourly Space Velocity (GHSV) is 100-15,000 per hour.

Once the catalyst is activated, it can be used in dry methane reforming operations. The catalyst can be loaded into a fixed bed or a fluidized bed reactor arrangement. The feedgas is CO₂:CH₄ at a ratio of 0.5:1 to 2.5:1. A preferred ratio is 1.5:1. The process occurs at 500-1000 degrees C. and at a pressure range of atmospheric pressure to 5 bars. The temperature ramping rate is 10-100 C per hour. The GHSV is 100-15,000 per hour. The reforming process occurs at temperatures below the eutectic temperature of the solid solution. For example, if the eutectic temperature is 900 degrees C., then the reforming process is below this temperature.

It should be known to those skilled in the art that the foregoing disclosure and showings made in the drawings are merely illustrative of the principles of this invention and are not to be interpreted in a limiting sense.

1. A dry reforming methane to synthesis gas catalyst, comprising:
a) A primary metal based material of magnesia (MgO), the primary metal based material having a first crystalline structure;
b) A secondary metal based material having a second crystalline structure, the secondary metal based material mixed with the primary metal based material;
c) The primary and secondary metal based materials heated so the first and second crystalline structures form a mono-crystalline structure.

2. The dry reforming methane to synthesis gas catalyst of claim 1 wherein the first crystalline structure has a first lattice parameter and the second crystalline structure has a second lattice parameter.

3. The dry reforming methane to synthesis gas catalyst of claim 2 wherein the second lattice parameter is within 2% of the first lattice parameter.

4. The dry reforming methane to synthesis gas catalyst of claim 1 wherein the secondary metal based material is taken from the group consisting of nickel oxide (NiO), cobalt oxide (CoO) and iron oxide (FeO).

5. The dry reforming methane to synthesis gas catalyst of claim 1, further comprising a tertiary metal based material that is different from the secondary metal based material and is taken from the consisting of nickel oxide (NiO), cobalt oxide (CoO) and iron oxide (FeO).

6. The dry reforming methane to synthesis gas catalyst of claim 1 wherein the primary metal based material and the secondary metal based material have a eutectic temperature, the primary metal based material and secondary metal based material have been calcined at a temperature above the eutectic temperature to form sintered metal oxides.

7. The dry reforming methane to synthesis gas catalyst of claim 1 further comprising a solid solution phase promoter.

8. The dry reforming methane to synthesis gas catalyst of claim 1, further comprising an alkalinity promoter.
